(19) United States
(12) Patent Application Publication
(10) Pub. No.: US 2017/0052932 A1
(43) Pub. Date: Feb. 23, 2017

(54) Systems and Methods for the Convenient Comparison of Text

(71) Applicant: Ian Caines, Toronto (CA)

(72) Inventor: Ian Caines, Toronto (CA)

(21) Appl. No.: 15/236,419

(22) Filed: Aug. 13, 2016

Related U.S. Application Data
(60) Provisional application No. 62/207,368, filed on Aug. 19, 2015.

(51) Int. Cl. G06F 17/22; G06F 17/24; G06F 3/0484; G06F 3/0486

(52) U.S. Cl. CPC G06F 17/2211; G06F 3/0486; G06F 17/24; G06F 17/2288; G06F 3/04847

(57) ABSTRACT

A system and method are provided for preparing and comparing passages of text in a manner that facilitates the convenient and rapid comparison of text by users of the system. In the given example, the method includes: providing means for the entering and editing of two passages of text, automatically determining differences between the passages of text as they are entered, displaying such differences to the user, and allowing the user to set and change certain parameters of the comparison process and see the results of such changes as they are made.

### TECHNICAL FIELD

The following relates generally to the editing and comparison of text with computers.

### DESCRIPTION OF RELATED ART

In certain fields of activity, such as law and accounting, it is often necessary to compare passages of text to determine similarities and differences between them. Algorithms for determining differences between passages of text are well known and a variety of software tools exist that are able to generate such comparisons, generally using two passages of text (which may be files on a computer or in other forms) as inputs. Examples of tools providing such functionality include Microsoft Word™, Workshare Compare™, the GNU diffutils package, and the web service available at http://text-compare.com.

While such tools allow documents or passages of text to be compared, users will often wish to compare passages of text that must be assembled from multiple sources or otherwise modified before a meaningful comparison is possible, or where the comparison process itself must be adjusted several times before a satisfactory comparison is achieved. Performing comparisons with existing tools in such circumstances is time consuming and cumbersome. For example, depending on the details of the tool being used, a user wishing to compare two arbitrary passages of text may need to prepare two separate files containing the texts to be compared, save those files onto the computer's storage, and then load the files into the software in order to perform a comparison. If the user desires to adjust the texts being compared after seeing the initial comparison, the original sources would need to be edited and reloaded into the tool to perform a further comparison. With other tools, it may be necessary for the user to repeatedly enter commands into the computer, through a keyboard, mouse or other device, in order to cause the comparison to be updated as the source texts are changed. Existing tools also either do not allow users to control parameters of the comparison process or do not allow users to easily see the consequences of changing such parameters on the comparison being performed.

As a result of these difficulties and impediments, users are discouraged from the use of existing tools and methods in cases where the use of such tools would be beneficial, and may therefore fail to notice critical differences between texts. The cumbersome nature of existing tools may also lead to errors in operation by the users.

In view of the limitations in existing tools, it is desirable to have systems and methods that simplify the comparison process for users by allowing a user to enter and edit passages of text and see comparisons of such texts as they are edited without the need for the user to perform any additional steps or take any additional actions. It is also desirable for users to be able to easily observe the consequences of changing parameters of the comparison process so as to facilitate the choice of a comparison that is most appropriate to a user's circumstances.

### SUMMARY

In an example embodiment of the invention, a computer based text comparison system is provided. The embodiment includes features allowing a user of the system to conveniently input and edit two passages of text and adjust certain parameters of the text comparison process, as well as features allowing the differences between the passages of text to be determined and displayed to the user. The computer system monitors the passages of text (as well as certain parameters of the text comparison process) for any changes and, upon the detection of any such changes, automatically re-determines the differences between the passages of text and displays the newly determined differences to the user.

### BRIEF DESCRIPTION OF THE DRAWINGS

Example embodiments will now be described by way of example only with reference to the appended drawings wherein:

FIG. 1 is an illustration of an example computer system for implementing a text comparison program, consistent with the disclosed embodiments.

FIG. 2 is a flow diagram of an example embodiment of computer executable or processor implemented instructions for the comparison of text.

FIG. 3 is an illustration of a graphical user interface (GUI) of an example embodiment of a text editing and comparison program.

FIG. 4 is a further illustration of the GUI of FIG. 1 where the user has typed additional text into the application.

FIG. 5 is a further illustration of the GUI of FIG. 1 where the user has changed the controls governing the comparison process.

FIG. 6 is a flow diagram of an example embodiment of computer executable or processor implemented instructions for handling text dragged into a program's GUI.

FIG. 7 is an illustration of the GUI of FIG. 1 showing a graphical overlay that is displayed when a user drags text into the program.

FIG. 8 is an illustration of a GUI of another example embodiment of a text editing and comparison program for use on a device with a touch sensitive display.

FIG. 9 is a further illustration of the GUI from FIG. 8 where the user has opted to edit the new text in the comparison.

FIG. 10 is a further illustration of the GUI from FIG. 9 where the user has typed additional text into the application.

FIG. 11 is an illustration of the GUI from FIG. 8 where the user has opted to edit the old text in the comparison.

### DETAILED DESCRIPTION

It will be appreciated that for simplicity and clarity of illustration, where considered appropriate, reference numerals may be repeated among the example figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details or with the details rearranged. In other instances, well-known methods, procedures and components have not been described in detail so as not to obscure the example embodiments described herein. Also, the description is not to be considered as limiting the scope of the example embodiments described herein.

Embodiments claimed may include one or more apparatuses for performing the operations herein. Such an apparatus may be specially constructed for the desired purposes, or it may comprise a general purpose computing device selectively activated and/or reconfigured by a program stored in the device. Such a program may be stored on a storage medium, such as, but not limited to, any type of disk including floppy disks, optical disks, CD-ROMs and/or magnetic-optical disks, read-only memories (ROMs), random access memories (RAMs), electrically programmable read-only memories (EPROMs), electrically erasable and/or programmable read only memories (EEPROMs), flash memory, magnetic and/or optical cards, and/or any other type of media suitable for storing electronic instructions, and/or capable of being coupled to a system bus for a computing device, computing platform, and/or other information handling system.

The processes and/or displays presented herein are not inherently related to any particular computing device and/or other apparatus. Various general purpose systems may be used with programs in accordance with the teachings herein, or a more specialized apparatus may be constructed to perform the desired method. The desired structure for an example of such a system will appear from the descriptions below. In addition, embodiments are not described with reference to any particular programming language. It will be appreciated that a variety of programming languages may be used to implement the teachings described herein.

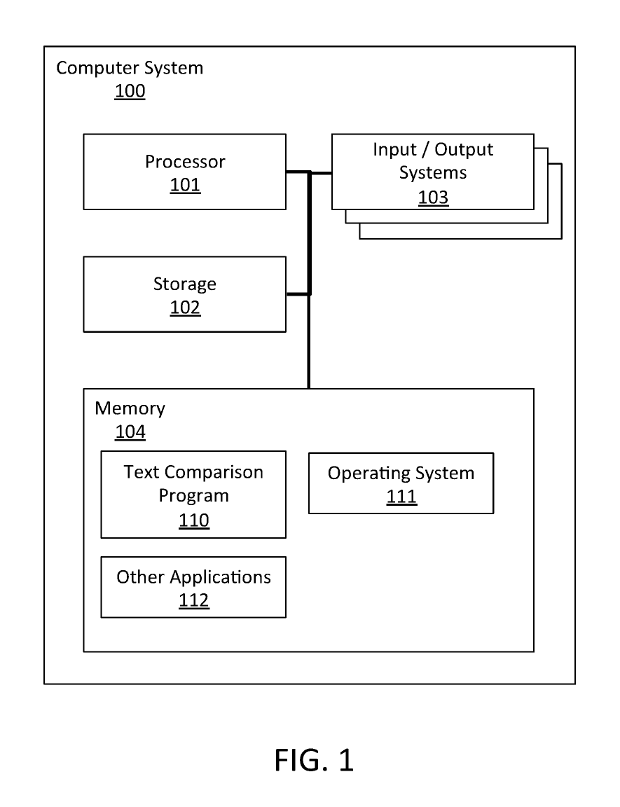

FIG. 1 illustrates an example embodiment of a computer system that may be used to implement the example embodiments of a text comparison system described below. The example computer system (100) is comprised of a processor (101) connected to storage (102), input and output systems (which may include a keyboard, mouse, display monitor, speakers, and/or other systems) (103) and memory (104). The memory contains instructions directing the computer system to carry out the text comparison processes describe below (110) as well as instructions for the operating system (111) and other computer applications (112). It will be appreciated by those ordinarily skilled in the art that the components, arrangement, and other details of the example computer system may be varied without straying from the concepts disclosed herein.

For simplicity, this description will refer to text, or passages of text, which may include sequences of one or more ASCII or Unicode characters, other symbols representing human language, computer code, bytes, or other information that may be stored in or processed by a computer system. Text may also include formatting information regarding the text. It will be understood by those of ordinary skill in the art that these examples are not exhaustive, and that the example embodiments described herein may operate on other forms of information or data that may be stored on or processed by a computer.

For convenience and consistency, when referring to two passages of text that are to be compared in the descriptions that follow, such passages of text will be referred to as the “old text” and the “new text”. The process of determining the differences between two passages of text will sometimes herein be referred to as the comparison of the texts.

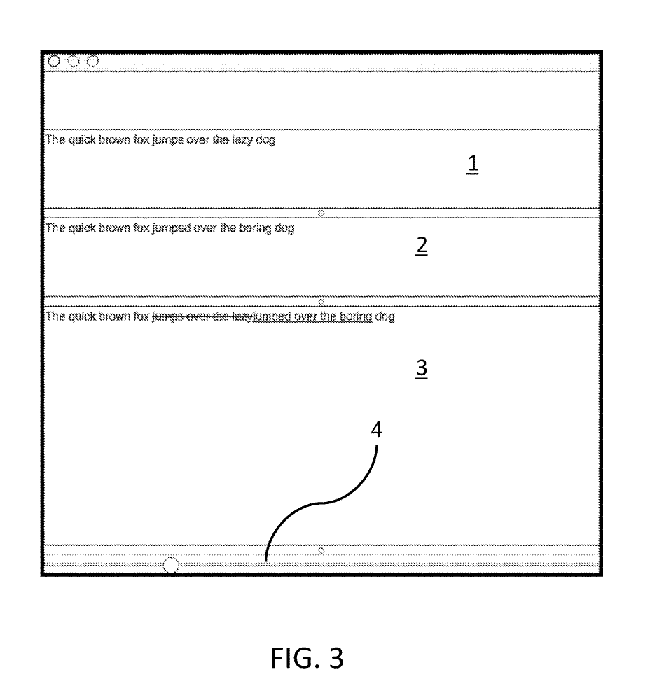

Often, in the case of texts representing human language, the differences between an old text and a new text are illustrated by producing a formatted amalgamated text containing all of the old text and the new text, with special formatting indicating which portions of text would need to be removed from, or added to, the old text in order to obtain the new text. One common convention is for portions of text that would need to be removed from the old text (which will be referred to for simplicity as deletions) to be shown struck-out with a horizontal line passing through the text, and portions of text that would need to be added to the old text (which will be referred to for simplicity as insertions) to be shown underlined. Sub-passages of text which are common to the old text and the new text (and are therefore neither insertions nor deletions) will be referred to as the matching text. An example of how the differences between two passages of text may be presented in this way (showing the difference between the texts “The quick brown fox jumps over the lazy dog” and “The quick brown fox jumped over the boring dog”) is shown in region 3 of FIG. 3. Such a comparison is often referred to as a “blackline” or a “redline”. It will be appreciated by those of ordinary skill in the art that other methods of presenting the differences between the old text and the new text may be used (such as by the use of different colors, fonts or characters, graphic illustrations of the changes, or other methods) and that other types of differences between the old text and the new text may also be presented to the user (such as indicating places where a sub-text has been moved from one location in the old text to a different location in the new text, where formatting of text has changed, and other types of differences).

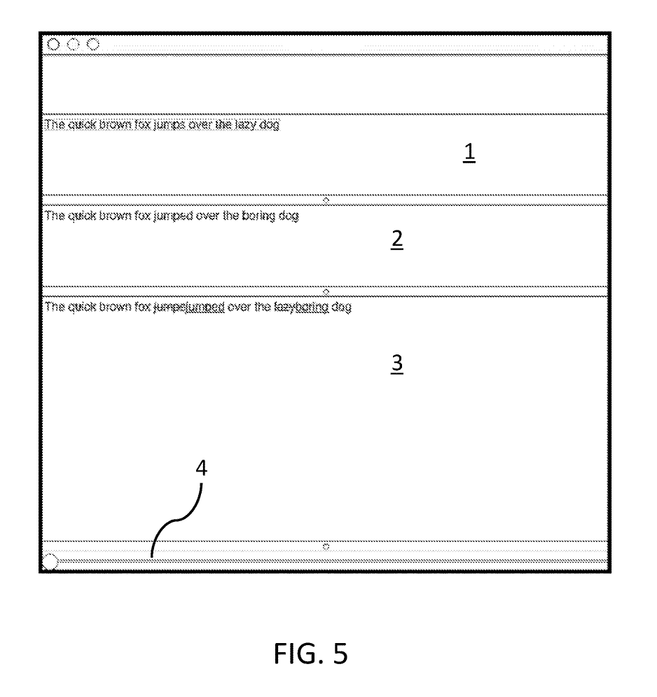

It will be understood by those of ordinary skill in the art that given any two passages of text there are often different possible ways of representing the differences between two passages in terms of insertions and deletions. For example, in the GUI illustrated in FIG. 3, region 3 shows the difference between the example texts as the deletion of “jumps over the lazy” and the insertion of “jumped over the boring”, however it might also be shown as the deletion of the words “jumps” and “lazy” and the insertion in place of those words of the words “jumped” and “boring”, respectively, as shown in region 3 of FIG. 5. Another possible representation would be to show all of the old text as deleted and all of the new text as inserted. Depending on the content and context, different representations of the differences between two passages of text may be most useful to the user. It will also be understood by those of ordinary skill in the art that there are various algorithms may be used for determining differences between two passages of text. For example, a particular representation of the differences between old text and new text may be selected by determining the representation of the differences that maximizes an objective function f(representation), where:

f(representation)=#of matched words in the representation

It will be apparent to those of ordinary skill in the art that a representation of the differences between two passages of text that maximizes such an objective function may be determined by means of dynamic programming. By way of background, dynamic programming is a method by which a problem is broken into sub-problems the solutions to which may be combined to solve the original problem.

In an example embodiment, a method performed by a computing device is provided for allowing users to enter and edit passages of text and automatically generate comparisons of the text. The example embodiment includes an application with a GUI for entering and editing passages of text, setting certain parameters of the comparison process, and displaying the results of the comparison of the texts. Whenever changes are made in the passages of input text, or the parameters for performing comparisons between the texts are changed, the application automatically re-determines the differences between the texts and displays the determined differences in the GUI.

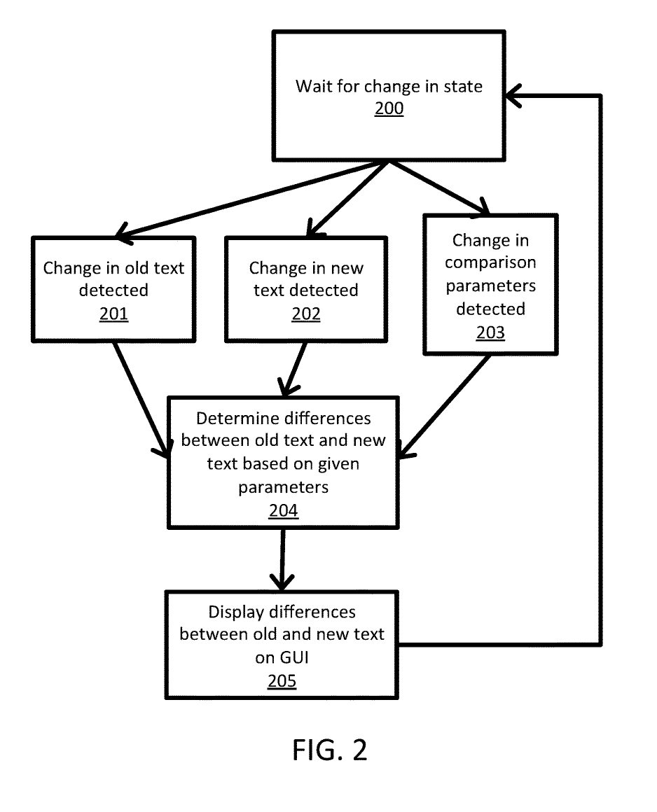

FIG. 2 provides a flow diagram illustrating the operation of the example embodiment of a text comparison application. A general overview of each operation is described below. Further details relating to the operation of the example embodiment are provided later in the description.

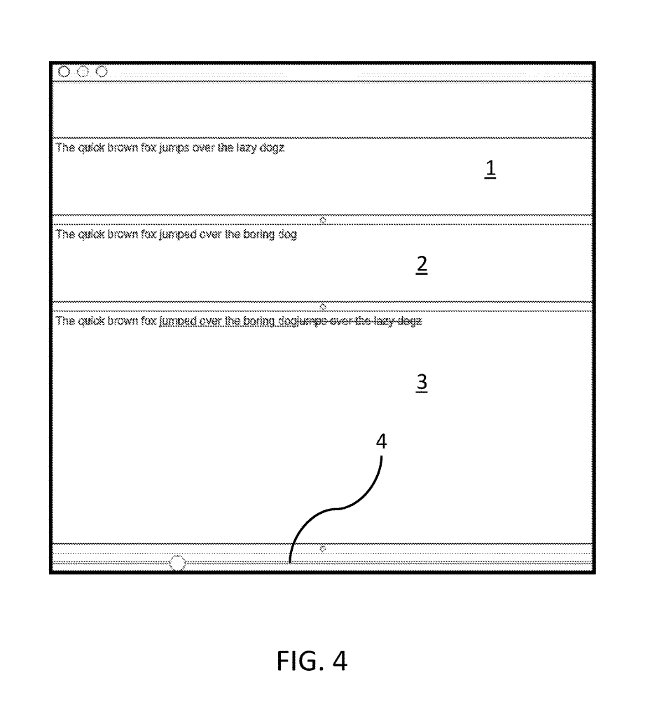

FIG. 3 shows an illustrative graphical user interface (GUI) of the example embodiment. The GUI includes two areas (1 and 2) in which text may be entered by the user. Old text is entered in 1 and new text is entered in 2. A third area (3) is provided in which the differences between the texts in 1 and 2 are displayed. The user may enter and edit text in 1 and 2 by manually typing text on a keyboard attached to the computer device, by copying and pasting text from other applications on the computer device, by deleting portions of the text in 1 or 2, or by other usual means that will be apparent to those ordinarily skilled in the art. The computer device monitors for any changes in the texts (200 in FIG. 2) and upon detecting any change in the old text or the new text (201 or 202) the computer device re-determines the differences between the texts (204), displays such differences in region in 3 of the GUI (205), and then proceeds to monitor for further changes (200). As an example of the operation of the embodiment, FIG. 4 shows the same GUI as in FIG. 3, where the user has typed an additional character “z” at the end of the old text in 1, and the application has updated the displayed comparison in 3 without the need for any additional action by the user.

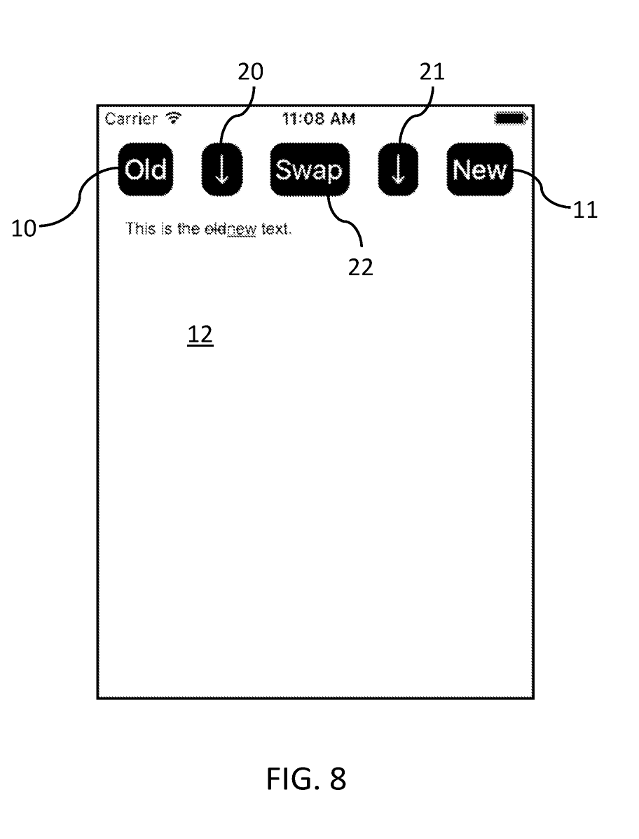

It will be appreciated by those of ordinary skill in the art that in other embodiments, the old text and new text (1 and 2) may not be visible to the user at all times, and may only be visible to the user at certain times, under certain conditions determined by the application, or at the option of the user (an example of the interface for such an embodiment is illustrated in FIG. 8, discussed below). In situations where the old text or the new text are not visible to the user it may still be possible for the user to edit such texts by means of the graphical overlay methods described below or by other methods. It will be further appreciated by those of ordinary skill in the art that the comparison displayed in the GUI (3) may be converted to other forms, and may be saved in the form of a file, such as in hypertext mark-up language (HTML) or portable document format (PDF), or other formats. It will be further appreciated by those of ordinary skill in the art that a computing device may carry out the process illustrated in FIG. 2 in parallel with other activities such that, for example, the user may be able to continue interacting with and editing the new text and old text while the computer device is carrying out the computations required by the steps in items 204 and 205.

It will be further appreciated by those of ordinary skill in the art that in other embodiments the application may limit the frequency at which the application will compare the old text and the new text (such as by preventing the application from comparing the old text and the new text more frequently than once per second, or other interval), or may give the user the ability to suspend the comparison of the old text and the new text. Such limitations may be especially useful for embodiments operated on battery powered computing devices, where it is desired to limit the amount of computation performed, and power consumed, by the operation of the embodiment. In other embodiments, the differences between the old text and the new text may be automatically determined at regular intervals, or otherwise periodically, rather than specifically in response to changes in the old text or the new text.

The GUI of the example embodiment includes a control (4) allowing the user to select a parameter of the comparison process. In the example embodiment, the application selects, by means of dynamic programming, a representation of the differences between the old text and the new text by selecting a representation that maximizes the objective function

g(representation)=#of matched words in the representation−α(#of contiguous passages of inserted or deleted text in the representation)

where α is a parameter of the comparison process. In the example embodiment control 4 determines the value of α to be used in the comparison. Upon any change in the control 4 (203 in FIG. 2), the differences between the old text and the new text will be re-determined (204) and displayed in the GUI 3 (205). In FIG. 3, control 4 has been set so that α is equal to 2, and the program selects a representation of the differences between the old text and the new text with 5 matched words, 1 contiguous passage of deleted text, and 1 contiguous passage of inserted text. FIG. 5 shows the same GUI where control 4 has been adjusted by the user so that α is zero (0), and the program therefore selects a representation of the differences between the old text and the new text with 7 matched words, 2 contiguous deletions, and 2 contiguous insertions. Depending on the circumstances and preferences of a user, one or the other of these representations may be a more useful way of presenting the differences between the texts.

It will be appreciated by those of ordinary skill in the art that there are several ways of expressing the objective function g(representation) that are effectively equivalent for the purposes of the maximization problem. It will be further appreciated by those of ordinary skill in the art that variations on the function g(representation) are possible by, for example, also taking account of the number of contiguous passages of matched text or other factors. It will further be appreciated by those ordinarily skilled in the art that additional controls may also be provided allowing the user to control other aspects of the comparison process (such as whether the program should favour matching certain types of text, ignore certain types of differences between the texts, and other parameters).

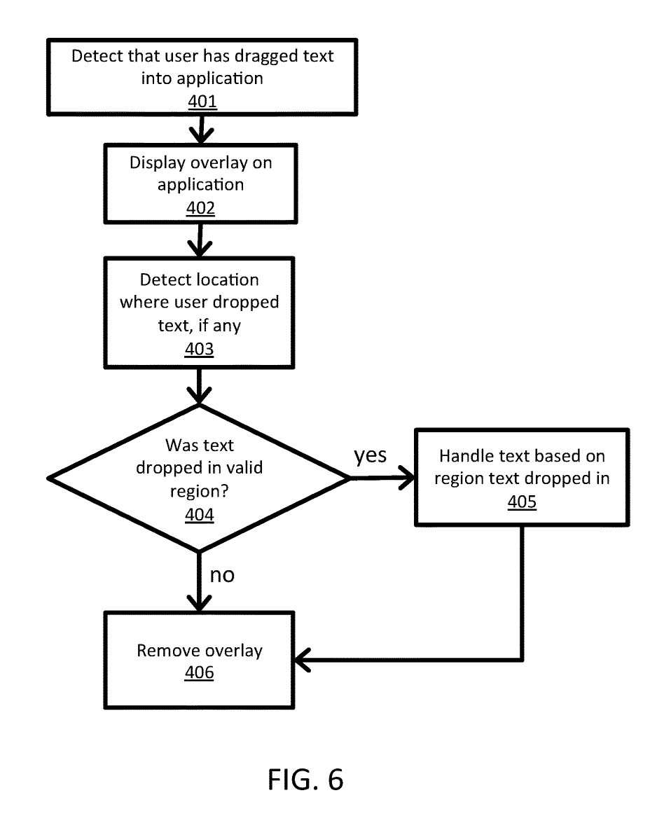

FIG. 6 provides a flow diagram illustrating the operation of the example embodiment when a user drags and drops text into the application's GUI. Text may typically be dragged into the application by selecting text in another application, placing the pointer over the text and holding down a mouse button while moving the pointer into the application, however many other common methods for dragging text may be used without straying from the concepts disclosed herein. When the application detects that the user has dragged text into the GUI of the application as part of a drag and drop operation (401), the embodiment displays a graphic overlay over some or all of the GUI presenting the user with different options for how the text will be used by the application, depending on where the text is dropped on the GUI (402). At the end of the drag and drop operation, the application determines where, if anywhere, the user dropped the dragged text (403). The application then determines whether the drop location was within one of the valid regions in the graphical overlay for dropping text (404) and, if so, the text is handled in a manner corresponding with the region in which the text was dropped by the user (405). In either case, the application removes the graphical overlay (406).

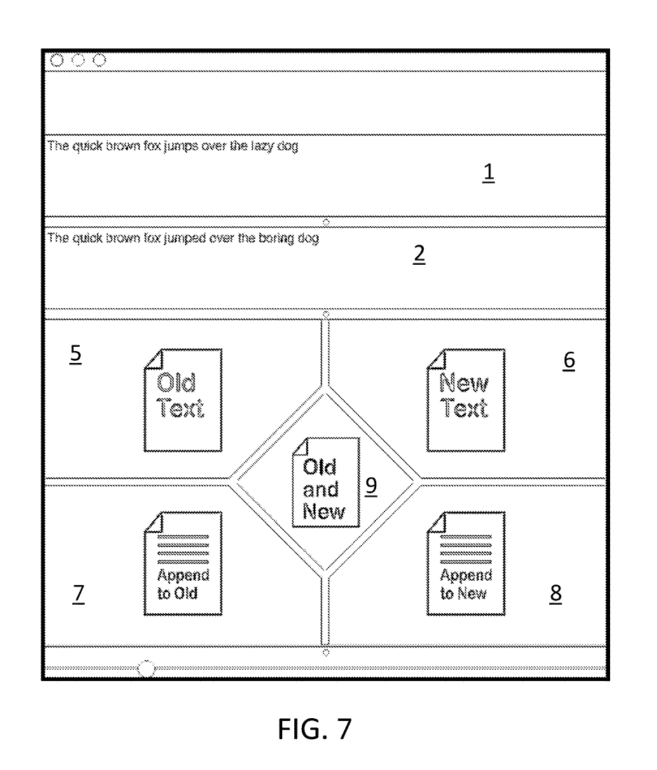

An illustration of the GUI in an example embodiment showing the overlay is provided by FIG. 7. In FIG. 7, the graphical overlay covers the region in which comparison text would be shown (3 from FIG. 3), but it will be apparent to those ordinarily skilled in the art that the graphical overlay could be shown over a different portion of the application's GUI, over all of the application's GUI or over a separate portion of the computer system's display.

The graphical overlay in the example embodiment consists of 5 regions (5, 6, 7, 8, and 9). Any text dropped by the user in region 5 will be used to replace the old text to be used by the application (that is, the text shown in 1). Any text dropped by the user in region 6 will be used by to replace the new text to be used by the application (that is, the text shown in 2). Any text dropped by the user on region 9 will be used to replace both the old text and the new text to be used by the application. Any text dropped by the user on region 7 will be appended to the end of the existing old text already entered into the application. Any text dropped by the user on region 8 will be appended to the end of the existing new text already entered into the application. Any such drop action that affects the old text or the new text (201 or 202 for FIG. 2) will trigger a re-determination of the differences between the old text and the new text (204) and the display of the new comparison (205).

It will be appreciated by those ordinarily skilled in the art that different configurations of regions may be shown on the graphical overlay, and that regions corresponding to actions beyond those exhibited in the example embodiment may also be utilized. It will be further appreciated by those ordinarily skilled in the art that such a graphical overlay may also be used to designate to the user regions for performing actions other than a drag-and-drop operation in order to achieve a particular result in the application (such as regions wherein the user may press a button on the user's mouse or other pointing device in order to use text from the operating systems clipboard as indicated for that region).

FIG. 8 shows an illustrative GUI of another example embodiment involving a computer system with a touch sensitive display. Such a computer system may include, without limitation, a mobile device, a tablet, a smartphone, or a laptop, desktop or other computer device with a touch sensitive display. The GUI includes a region (12) to display the differences between two passages of text, as well as a number of controls (10, 11, 20, 21, and 21) to allow the user to manipulate the texts and the comparisons. In the example shown in FIG. 8, the old text being compared is “This is the old text.” and the new text being compared is “This is the new text”. In the example embodiment illustrated in FIG. 8, the user may cause the old text to be replaced with the text present on the common clipboard of the computer system by actuating control 20 (for example, by tapping on that control), may cause the new text to be replaced with the text present on the common clipboard of the computer system by actuating control 21, and may cause the old text and the new text to be swapped with each other by actuating control 22. Upon any change in the old text and/or the new text, the differences between the old text and the new text are automatically re-determined by the application and displayed in area 12 of the GUI. By actuating control 10 or 11, the user may cause the application to display a different interface allowing the editing of the old text or new text, respectively. It will be appreciated by those of ordinary skill in the art that additional controls may be added to the GUI to allow the user to effect other changes to the old and new texts and the comparison of such texts and that other means may be used to allow the user to indicate the actions to be taken by the application, such as by detecting different patterns of user contact on the display.

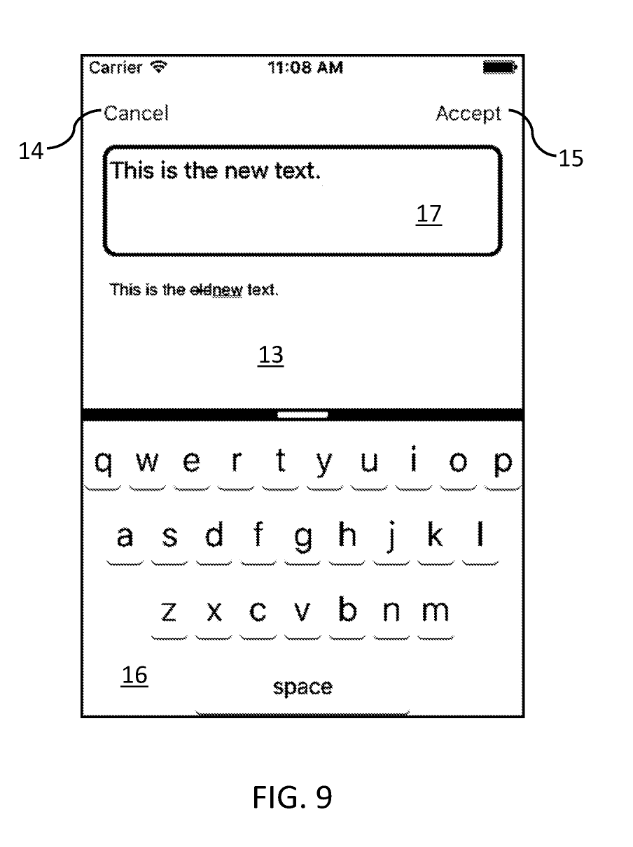

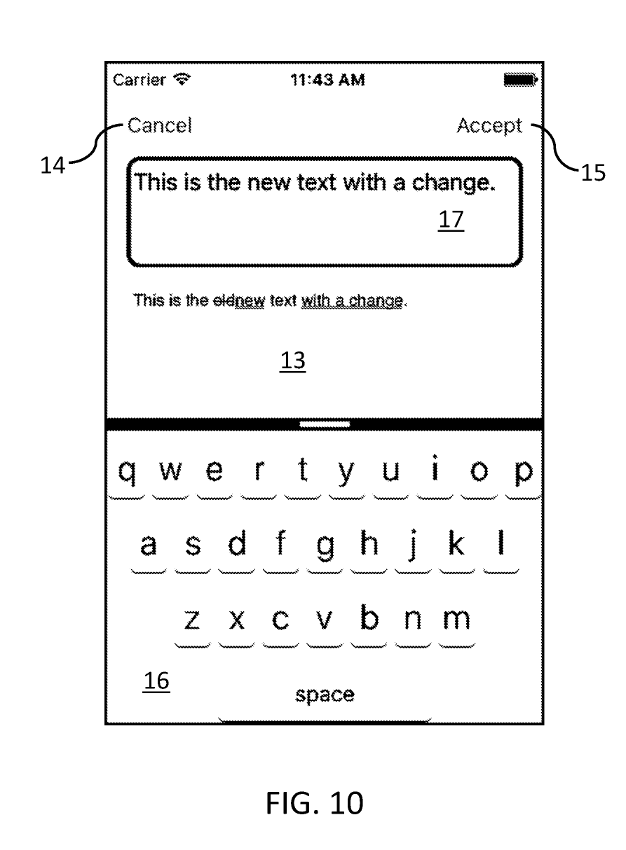

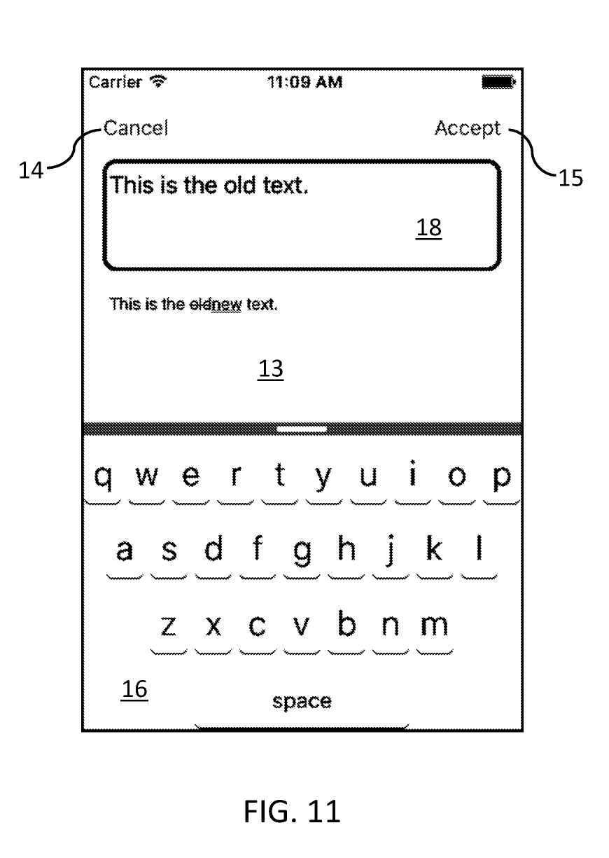

FIG. 9 shows the same GUI as in FIG. 8 after the user has actuated control 11 on FIG. 8. The GUI continues to include a region (13) where the comparison of the old and new texts is displayed, but now also includes a region (17) where the new text is displayed, and a keyboard (16) allowing the user to input edits to the new text. Upon any change in the new text the differences between the old text and the new text are automatically re-determined by the application and displayed in area 13 of the GUI. FIG. 10 show the same GUI as FIG. 9 where the user has added the words “with a change” to the new text. When the user has completed making the desired changes to the new text, the user may actuate a control (15) to return to the prior display shown in FIG. 8. The user may actuate a separate control (14) to instead discard any changes made to the new text (restoring the new text to its state before the beginning of the editing operation) and return to the display shown in FIG. 8. By actuating control 10 on FIG. 8 the user may cause the application to display a similar interface for editing the old text, as shown in FIG. 11. This interface shown in FIG. 11 is similar to that shown in FIG. 9, except that instead of displaying the new text it includes a region (18) for the display and editing of the old text.

General example embodiments of the system and method are provided below.

In an example embodiment, a method performed by a computing device to manipulate and compare of passages of text includes: starting an application with a graphical user interface (GUI) in memory; displaying the GUI on a display devise of the computing device; allowing users to enter and edit, via an input device of the computing device, two passages of text; detecting changes in the passages of text, automatically determining the differences between the two passages of text responsive to a change in the texts; and displaying the differences between the two passages of text in the GUI. A computer system is provided that includes a processor, memory storing the instructions to carry out the method, an input device and a display device.

In an example aspect, in addition, the GUI provides controls allowing the user to set parameters for comparing the text, and the displayed differences between the passages of text are automatically updated whenever the parameters are changed by the user.

In another example aspect, the parameters that are set include the degree to which the application should favour providing a comparison with fewer contiguous passages of deleted text.

In another example aspect, the parameters that are set include the degree to which the application should favour providing a comparison with fewer contiguous passages of inserted text.

In another example aspect, the parameters that are set include the degree to which the application should favour providing a comparison with fewer contiguous passages of matched text.

In another example aspect, the method further include: detecting when the user has dragged text from another source into the application's GUI; displaying a graphical overlay over all or part of the application's GUI (or over another region of the display device of the computer system) comprising multiple regions corresponding with different ways that the dragged text can be used by the application; determining the region into which the user drops the dragged text; and utilizing the dragged text in a manner consistent with the region in which the text is dropped by the user.

In another example aspect, responsive to detecting that the dragged text is dropped into a particular region on the graphical overlay, one of the passages of text (that is, the old text or the new text) is modified by appending the dragged text to such passage of text.

In another example aspect, responsive to detecting that the dragged text is dropped into a particular region on the graphical overlay, one of the passages of text is modified by prepending the dragged text to such passage of text.

In another example aspect, responsive to detecting that the dragged text is dropped into a particular region on the graphical overlay, one of the passages of text is replaced with the dragged text.

In another example aspect, responsive to detecting that the dragged text is dropped into a particular region on the graphical overlay, both of the passages of text are modified by appending the dragged text to such passages of text.

In another example aspect, responsive to detecting that the dragged text is dropped into a particular region on the graphical overlay, both of the passages of text are modified by prepending the dragged text to such passages of text.

In another example aspect, responsive to detecting that the dragged text is dropped into a particular region on the graphical overlay, both of the passages of text are replaced with the dragged text.

In another example embodiment, a method performed by a computing device to manipulate and compare of passages of text, includes: providing an application comprising a graphical user interface (GUI) allowing users to enter and edit two passages of text; detecting changes in the passages of text, automatically determining the differences between the two passages of text at regular intervals; and displaying the differences between the two passages of text. A computer system is provided that includes a processor, memory storing the instructions to carry out the method, an input device and a display device.

It will be appreciated that the particular example embodiments shown in the figures and described above are for illustrative purposes only and many other variations can be used according to the example embodiments described. Although the above has been described with reference to certain specific example embodiments, various modifications thereof will be apparent to those ordinarily skilled in the art as outlined in the appended claims. It will also be appreciated that aspects of the example GUI illustrated in the figures include features that are designed to appeal to the eye and that may vary in another artist's rendition of the example embodiments.

1. A computer system for carrying out text comparisons, comprising:
a processor;
memory coupled to the processor, the memory storing instructions to direct the computer system to at least:
provide a graphical user interface (GUI) allowing users to enter and edit two passages of text;
detect changes in the passages of text;
automatically determine the differences between the two passages of text responsive to detecting a change in the texts; and
display the differences between the two passages of text in the GUI;
an input device or devices to provide input to the GUI; and
a display device to display the GUI.

2. The computing system of claim 1, wherein, in addition, the GUI provides controls allowing the user to set one or more parameters for comparing the passages of text, and responsive to any change in such parameters the differences between the passages of text are automatically determined and displayed to the user.

3. The computing system of claim 2, wherein the parameters that are set include the degree to which the application should favour providing a comparison with fewer contiguous passages of deleted text.

4. The computing system of claim 2, wherein the parameters that are set include the degree to which the application should favour providing a comparison with fewer contiguous passages of inserted text.

5. The computing system of claim 2, wherein the parameters that are set include the degree to which the application should favour providing a comparison with fewer contiguous passages of matched text.

6. The computing system of claim 1, wherein the memory stores additional instructions to direct the computing system to at least:
detect when the user has dragged text from another source into the application's GUI;
display, over a portion of the application's GUI, a graphical overlay comprising multiple regions corresponding with different ways that the dragged text can be used by the application;
determine the region into which the user drops the dragged text; and
utilize the dragged text in a manner consistent with the region in which the text is dropped by the user.

7. The computing system of claim 6, wherein, responsive to detecting that the dragged text is dropped into a particular region on the graphical overlay, one of the passages of text is modified by appending the dragged text to such passage of text.

8. The computing system of claim 6, wherein, responsive to detecting that the dragged text is dropped into a particular region on the graphical overlay, one of the passages of text is replaced with the dragged text.

9. The computing system of claim 6, wherein, responsive to detecting that the dragged text is dropped into a particular region on the graphical overlay, both of the passages of text are modified by appending the dragged text to such passages of text.

10. The computing system of claim 6, wherein, responsive to detecting that the dragged text is dropped into a particular region on the graphical overlay, both of the passages of text are replaced with the dragged text.

11. A method performed by a computing device to manipulate and compare passages of text, comprising:
starting an application with a graphical user interface (GUI) in memory, the GUI displayed on a display devices of the computing device;
receiving, via an input device of the computing device, input into the GUI to enter and edit two passages of text;
detecting, by a processor, changes in the passages of text;
automatically determining the differences between the two passages of text responsive to a change in the texts; and
displaying, in the GUI, the differences between the two passages of text.

12. The method of claim 1, wherein, in addition, the GUI provides controls allowing the user to set one or more parameters for comparing the passages of text, and responsive to any change in such parameters the differences between the passages of text are automatically determined and displayed to the user.

13. The method of claim 12, wherein the parameters that are set include the degree to which the application should favour providing a comparison with fewer contiguous passages of deleted text.

14. The method of claim 12, wherein the parameters that are set include the degree to which the application should favour providing a comparison with fewer contiguous passages of inserted text.

15. The method of claim 12, the parameters that are set include the degree to which the application should favour providing a comparison with fewer contiguous passages of matched text.

16. The method of claim 1, further comprising:
detecting, by a processor, when the user has dragged text from another source into the application's GUI;
displaying over a portion of the application's GUI a graphical overlay comprising multiple regions corresponding with different ways that the dragged text can be used by the application;
determining, by a processor, the region into which the user drops the dragged text; and
utilizing the dragged text in the application in a manner consistent with the region in which the text is dropped by the user.

17. The method of claim 16, wherein responsive to detecting that the dragged text is dropped into a particular region on the graphical overlay, one of the passages of text is modified by appending the dragged text to such passage of text.

18. The method of claim 16, wherein responsive to detecting that the dragged text is dropped into a particular region on the graphical overlay, one of the passages of text is replaced with the dragged text.

19. The method of claim 16, wherein responsive to detecting that the dragged text is dropped into a particular region on the graphical overlay, both of the passages of text are modified by appending the dragged text to such passages of text.

20. The method of claim 16, wherein responsive to detecting that the dragged text is dropped into a particular region on the graphical overlay, both of the passages of text are replaced with the dragged text.
